(19) United States
(12) Patent Application Publication
(10) Pub. No.: US 2013/0265398 A1
(43) Pub. Date: Oct. 10, 2013

(54) Three-Dimensional Image Based on a Distance of a Viewer

(71) Applicant: Bradley Neal Suggs, Sunnyvale, CA (US)

(72) Inventor: Bradley Neal Suggs, Sunnyvale, CA (US)

(21) Appl. No.: 13/819,103

(22) PCT Filed: Oct. 29, 2010
(86) PCT No.: PCT/US2010/054620

§ 371 Date: Feb. 26, 2013

(51) Int. Cl. H04N 13/04

(52) U.S. Cl. CPC H04N 13/0402
USPC 348/54

(57) ABSTRACT

Embodiments disclosed herein relate to determining a three-dimensional image based on a distance of a viewer from a display 104. A processor 102 may determine the position of a right eye image and a left eye image based on information from a sensor 106 about the distance of the viewer from the display 104. The right eye image and the left eye image may be displayed based on the determined position.

### BACKGROUND

Three-dimensional photographs and videos are becoming increasingly common. A three-dimensional image may be created such that an object in the image appears to have depth. The depth may make the object appear to be closer to or farther from the viewer. As a result, a three-dimensional image may appear more realistic to a viewer than a two-dimensional image.

### BRIEF DESCRIPTION OF THE DRAWINGS

In the accompanying drawings, like numerals refer to like components or blocks. The drawings describe example embodiments. The following detailed description references the drawings, wherein:

FIG. 1 is a block diagram illustrating one example of a computing system.

FIG. 2 is a block diagram illustrating one example of a computing system.

FIG. 3A is a diagram illustrating one example of a three-dimensional image perceived by a viewer.

FIG. 3B is a diagram illustrating one example of a three-dimensional image perceived by a viewer.

FIG. 4 is a flow chart illustrating one example of a method to determine a three-dimensional image based on a distance of a viewer from a display.

FIG. 5A is a diagram illustrating one example of updating a relative position of a right eye image and a left eye image based on a distance of a viewer from a display.

FIG. 5B is a diagram illustrating one example of updating a relative position of right eye image and a left eye image based on a distance of a viewer from a display.

FIG. 6 is a diagram illustrating one example of updating the focus of a three-dimensional image based on a target distance from a display.

FIG. 7 is a diagram illustrating one example of updating a target distance of a three-dimensional image from a display based on the distance of a viewer from the display.

FIG. 8 is a diagram illustrating one example of updating a relative position of a right eye image and a left eye image based on the distance between a viewer's eyes.

### DETAILED DESCRIPTION

Three-dimensional images may be created to provide the illusion that an image has depth. For example, a three-dimensional image may be created by having a displacement between an image viewed by the viewer's right eye and an image viewed by the viewer's left eye. The displacement may provide an illusion of depth by causing the images to appear to the viewer as if one image is in front of the other. The amount of displacement between the right eye image and the left eye image may affect the distance that the three-dimensional image appears from the viewer. Different amounts of displacement may be used on different parts of an object so that part of an object appears farther from the viewer and part of the same object appears closer to a viewer. As a result, the object may appear to have depth. The displacement between different portions of the image may be altered to affect how dose each object in an image appears to the viewer. For example, in a three-dimensional movie, one character may appear closer to the viewer than another character.

A three-dimensional image may be created by altering the relative position of a right eye image and a left eye image. For example, in some cases, two images are displaced from one another, and special glasses are worn that control which image is viewed of each eye. For example, glasses with a red lens and blue lens or glasses with polarized lenses may be worn. As another example, shutter glasses may be worn, such as shutter glasses that control which light associated with an image is allowed to pass through each lens. Some displays direct images to each eye without the use of special glasses. For example, the display itself, such as an autostereoscopic display, may direct a separate image to each of the viewer's eyes. With an autostereoscopic display, the angle between the right eye and the left eye image may be shifted to give a perception of a displacement between the imaged directed to the right eye and the image directed to the left eye.

In some cases, a viewer's distance from a display may cause a three-dimensional image to appear closer to or farther from the viewer than intended. For example, if a viewer is closer to the display, a three-dimensional image may have a projected depth behind the viewer's head causing the viewer to instead see two sets of lines without a three-dimensional depth effect. In some cases, a viewer may move closer or farther from the display. As the viewer moves, the position of the three-dimensional image may appear to move also. For example, an image may appear to a viewer to be in front of the display. As a viewer moves closer to the display, the image may appear to move closer to the display. If a viewer steps closer to a display to interact with the image, the image may appear to move farther from the viewer making it difficult for the viewer to interact with the image. If a viewer moves farther from the display, the image may appear to move away from the display and towards the viewer. Similar problems may occur for an image appearing to a viewer to have a depth behind the surface of the display.

In one embodiment, a sensor senses the distance of a viewer from a display, and a relative position of a right eye image and a left eye image is determined based on the distance of the viewer from the display. For example, an actual displacement may be altered, such as where glasses are worn, or a virtual displacement may be altered, such as where an autostereoscopic display is used. The relative position may be altered such that the three-dimensional image appears to the viewer to be a target distance from the display.

A target distance may be selected such that the three-dimensional image is perceived at a desired distance in front of or behind the surface of the display, if a viewer moves closer to the display, the three-dimensional image may be altered so that it appears to stay in the same position as the viewer moves closer to the image. For example, as a viewer moves closer to the display, the displacement between the right eye image and the left eye image may be increased so that the depth of the image is perceived to be similar to as before the viewer moved closer to the display. Adjusting the depth of an image based on the distance of the viewer may be used, for example, if a viewer is interacting with a three-dimensional image to ensure that the image does not move as the viewer moves closer or farther from the display to interact with the image. As another example, if a viewer is playing a video game closer to a display, the displacement may be altered to be smaller such that it continues to appear in three-dimensions from a closer viewer position.

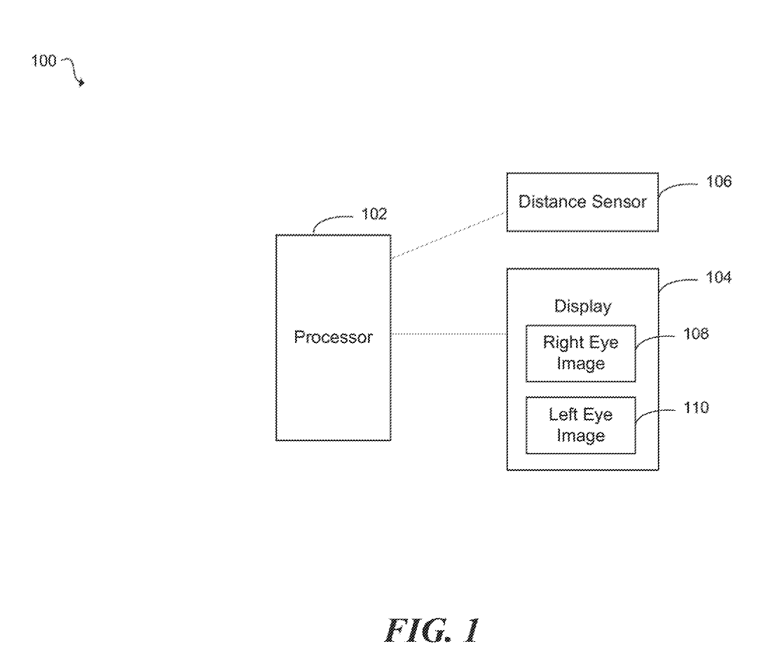

FIG. 1 is a block diagram illustrating one example of a computing system. The computing system 100 includes a processor 102, a display 104, and a distance sensor 106. The display 104 may be any suitable display, such as a Liquid Crystal Display (LCD). The display 104 may in some cases not include special characteristics tailored for three-dimensional images. For example, the display 104 may display images viewable in three-dimensions using glasses, such as polarized or colored images, The display 104 may be tailored to display three-dimensional images. For example, the display 104 may be an autostereoscopic display. The display 104 may show a right image 108 and a left eye image 110. The right eye image 108 and the left eye image 110 may appear to a viewer as a three-dimensional image. The relative position of the right eye image 108 and the left eye image 110 may be adjusted to change how close or far the image appears to a viewer in front of or behind the surface of the display 104.

The distance sensor 106 may be any suitable sensor for sensing the distance of a viewer from the display 104. For example, the distance sensor 106 may be an optical sensor, such as a camera, stereo sensor, time of flight sensor, structured light sensor, or an infrared depth map. The distance sensor 106 may be, for example, an acoustic sensor. The distance sensor 106 may sense the distance of any portion of a viewer from the display 104. For example, the distance sensor 106 may sense the distance of a viewer's head, eyes, or body from the display 104. The distance sensor 106 may measure the distance of the viewer from any portion of the display 104, such as the middle of the display 104 or a portion of the display 104 showing a particular image, The distance sensor 106 may measure multiple viewers. The computing system 100 may include multiple sensors where each sensor measures the distance of one viewer or a subset of the viewers from the display 104, such as viewers in a particular area relative to the display 104.

The processor 102 may be any suitable processor, such as a central processing unit (CPU), a semiconductor-based microprocessor, or any other device suitable for retrieval and execution of instructions. in one embodiment, the computing system 100 includes logic instead of or in addition to the processor 102. As an alternative or in addition to fetching, decoding, and executing instructions, the processor 102 may include one or more integrated circuits (ICs) or other electronic circuits that comprise a plurality of electronic components for performing the functionality described below. The computing system 100 may include multiple processors. For example, one processor may perform some functionality and another processor may perform other functionality.

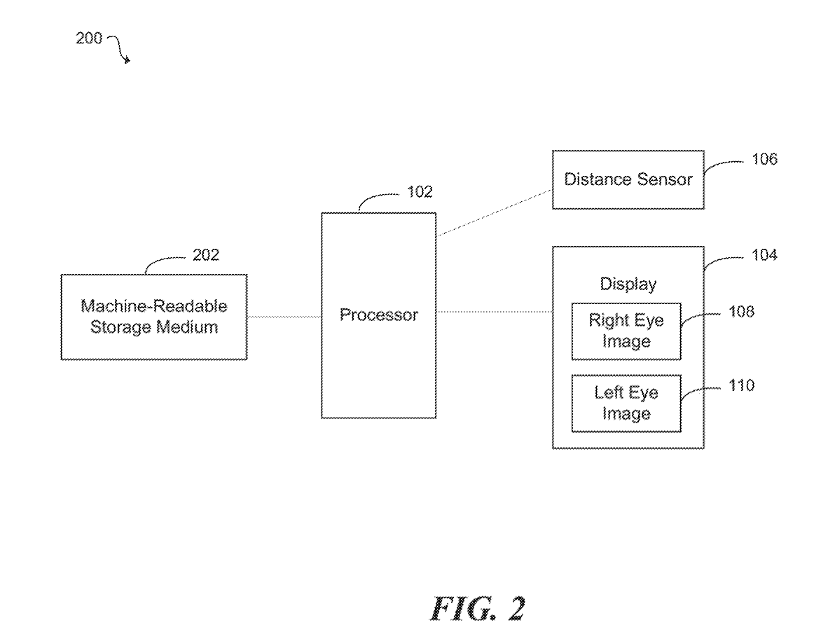

FIG. 2 is a block diagram illustrating one example of a computing system 200. The computing system 200 includes the processor 102, the distance sensor 106, and the display 104 including the right eye image 108 and the left eye image 110. The computing system 200 includes a machine readable storage medium 202. The machine-readable storage medium 202 may be any electronic, magnetic, optical, or other physical storage device that stores executable instructions or other data (e.g., a hard disk drive, random access memory, flash memory, etc,). The machine-readable storage medium 202 may be, for example, a computer readable non-transitory medium. The machine-readable storage medium 202 may include instructions executable by the processor 102, for example, instructions to determine a comparative position of the right eye image 108 and the left eye image 110 based on information from the distance sensor 106 indicating the distance of a user from a display 104, where the determined comparative position comprises a comparative position determined to make the collective right eye image 108 and left eye image 110 appear to the user as if at a desired distance from the display 104. The machine-readable storage medium 202 may further include instructions to display the right eye image 108 and left eye image 110 on the display 104 based on the determined comparative position of the right eye image 108 and the left eye image 110.

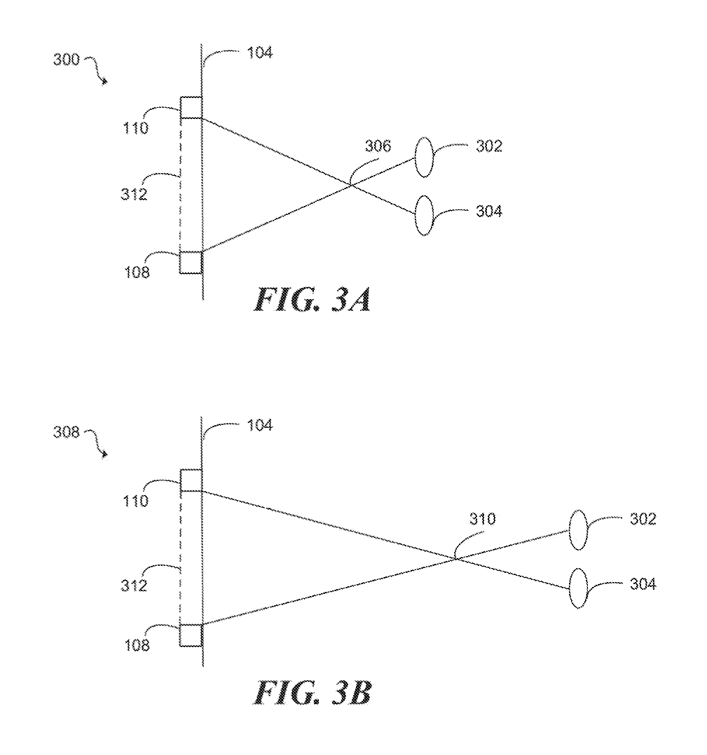

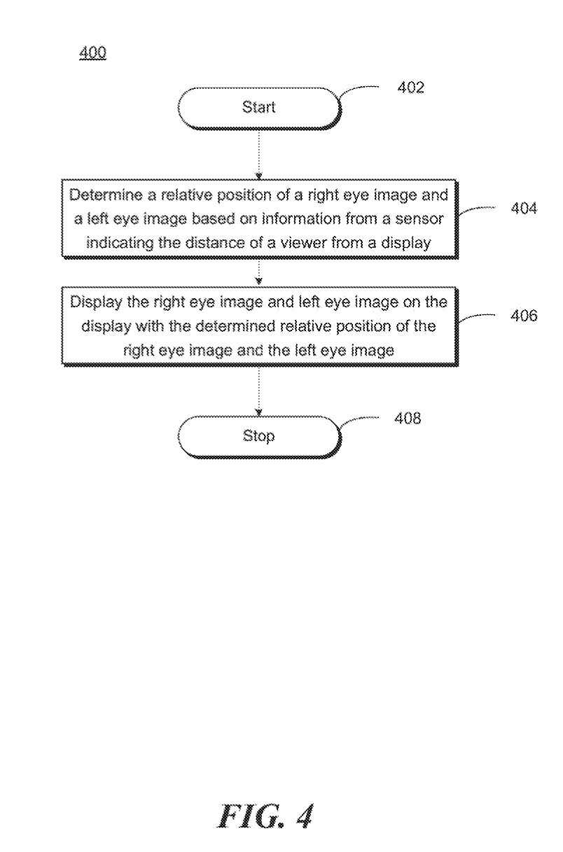

FIG. 3A is a diagram illustrating one example 300 of a three-dimensional image perceived by a viewer. For example, the image consists of the right eye image 108 and the left eye image 110 shown on the display 104 with a displacement 312 between the right eye image 108 and the left eye image 110. A viewer has a right eye 302 and a left eye 304 where the fight eye 302 focuses on the right eye image 108 and the left eye 304 focuses on the left eye image 110. The path from right eye 302 to the right eye image 108 intersects the path from left eye 304 to the left eye image at an intersection 306. Together the right eye 302 and the left eye 304 may perceive the image to be at the position of the intersection 306.

FIG. 3B is a diagram illustrating one example 308 of a three-dimensional image perceived by a viewer. The displacement between the right eye image 108 and the left eye image 110 remains the same displacement 312 in the example 308 as in the example 306. The viewer may move such that the right eye 302 and the left eye 304 are farther from the display 104. As a result, the path between the right eye 302 and the right eye image 108 intersects the path between the left eye 304 and the left eye image 110 at an intersection 310. The image may appear to be at the position of the intersection 310 which is farther from the surface of the display 104 than the intersection 306. The movement of the viewer relative to the display 104 caused the position of the image to change. A similar effect occurs if a three-dimensional image is shown to he displayed behind the surface of the display 104.

FIG. 4 is a flow chart illustrating one example of a method 400 to determine a three-dimensional image based on a distance of a viewer from a display. For example, the relative position of a right eye image and a left eye image of a three-dimensional image may be determined based on information from a sensor about a viewer's distance from the display. The image may be determined such that it appears to the viewer as a target distance from the display. The right eye image and left eye image may then be shown on the display with the determined relative position. The method 400 may be executed, for example, on the computing system 100.

Beginning at block 402 and moving to block 404, a processor, such as by executing instructions stored in a machine-readable storage medium, determines a relative position of a right eye image and a left eye image based on information from a sensor indicating the distance of a viewer from a display. The determined relative position may include a relative position determined to make the combined right eye image and left eye image appear on the display as if at a target distance from the display, such as a target distance in front of or behind the surface or the display. For example, the collective right eye image and left eye image may appear to the viewer as a single image with a depth at a target distance from the display.

The display may be any suitable display for displaying a three-dimensional image. In some implementations, the display may display a two dimensional image viewable in three-dimensions through special glasses. The display may include features for directing a separate image at each of the viewer's eyes without the use of special glasses.

The sensor may be any suitable sensor for indicating the distance of a user from the display, such as a camera or infrared depth map. The sensor may sense the distance of any suitable portion of a viewer to any suitable portion of the display, such as the distance between the viewer's head from the center of the display. The sensor may send an image to a processor, and the processor determines the distance of the viewer from the display based on the image. The sensor may communicate with the processor in any suitable manner, such as directly or via a network.

The target distance from the display may be any suitable desired distance, For example, the target distance may be a more approximate or more exact distance. The target distance may be a distance in front of or behind the surface of the display 104 such that the image may appear to come towards a viewer and out of the display or away from a viewer and into the display. The processor may determine the target distance or receive the target distance, such as from a storage or from another electronic device. In some cases, the target distance may be based on a previous distance of the image from the viewer. For example, if an image is displayed to a viewer to appear at a particular distance, the target distance may be determined such that the image does not appear to move closer or farther from the display when a viewer moves closer or farther from the display.

The relative position of the right eye and left eye image may be any suitable comparative position between the two images, and the relative position may be altered in any suitable manner. An angle, distance, or other characteristic between the two images may be altered. For example, an actual or virtual displacement between the two images may be charged, such as the displacement 312 shown in FIG. 3A and FIG. 3B. The displacement may be shorter to make the three-dimensional image appear farther in front of the display and closer to the viewer or longer to make the three-dimensional image appear closer in front of the display and farther from the viewer.

The processor may determine the relative position of the right eye image and the left eye image in any suitable manner. For example, the processor may look up a distance in a lookup table, such as a table correlating a target distance and a displacement. The processor may receive a correlation factor relating to a correlation between a target distance and a relative position, such as a displacement, between the two images. In some cases, the processor may attempt to make an object to appear as a target distance from the viewer, and the processor may adjust different portions of the object by the same or different factors. For example, the portion of an object farther from the viewer may have the displacement between the right eye and left eye image adjusted more or less than the displacement of the portion of the object closer to the viewer. In some cases, the relative position of the right eye image and the left eye image may depend on the type of technology used to display the three-dimensional image, such as whether glasses are used or a three-dimensional display is used.

The processor may determine a relative position of the right eye image and the left eye image such that the image appears to be a three-dimensional image. For example, the target distance may be a closer distance to the display if the viewer is closer to the display so that the two images appear as a single image at the target distance from the display rather than as two separate two-dimensional images on the display. The effect may be achieved, for example, by having a larger displacement between the right eye image and the left eye image.

Moving to block 406, a processor, such as by executing instructions stored in a machine-readable storage medium, displays the right eye image and left eye image on the display with the determined relative position of the right eye image and the left eye image. For example, the right eye image and the left eye image may be displayed with a greater distance between them or at a different angle relative to one another. The display may display the right eye and left eye image in any suitable manner, such as where each image is shown in a different color or directed to a different eye using a lens or other method. The viewer may perceive the displayed image as the target distance from the display. The method 400 continues to block 408 to end.

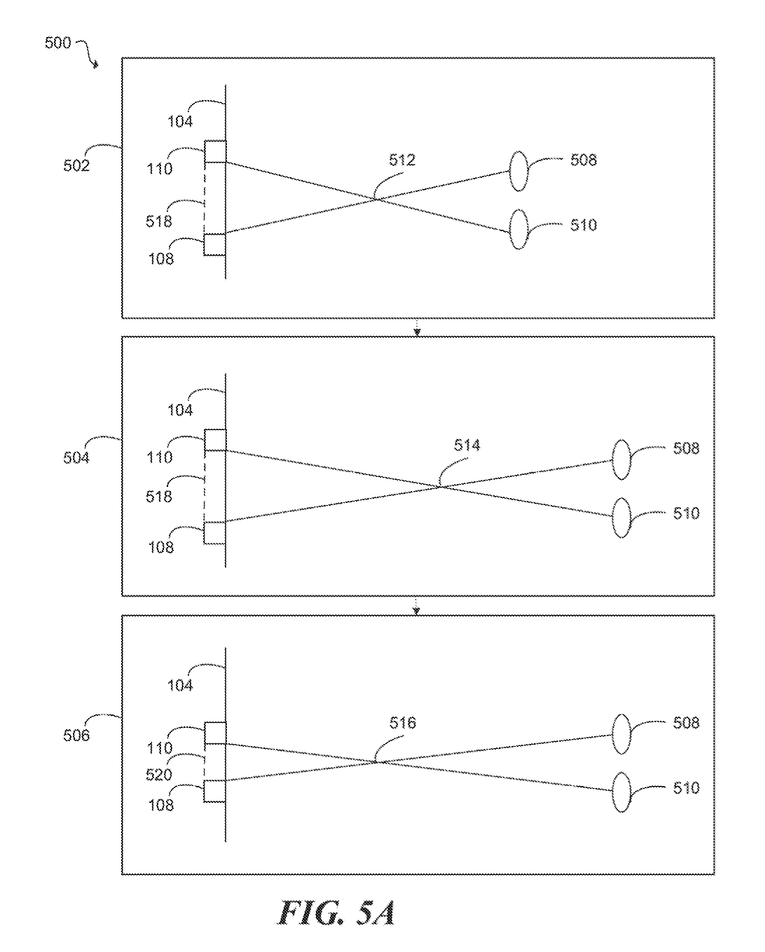

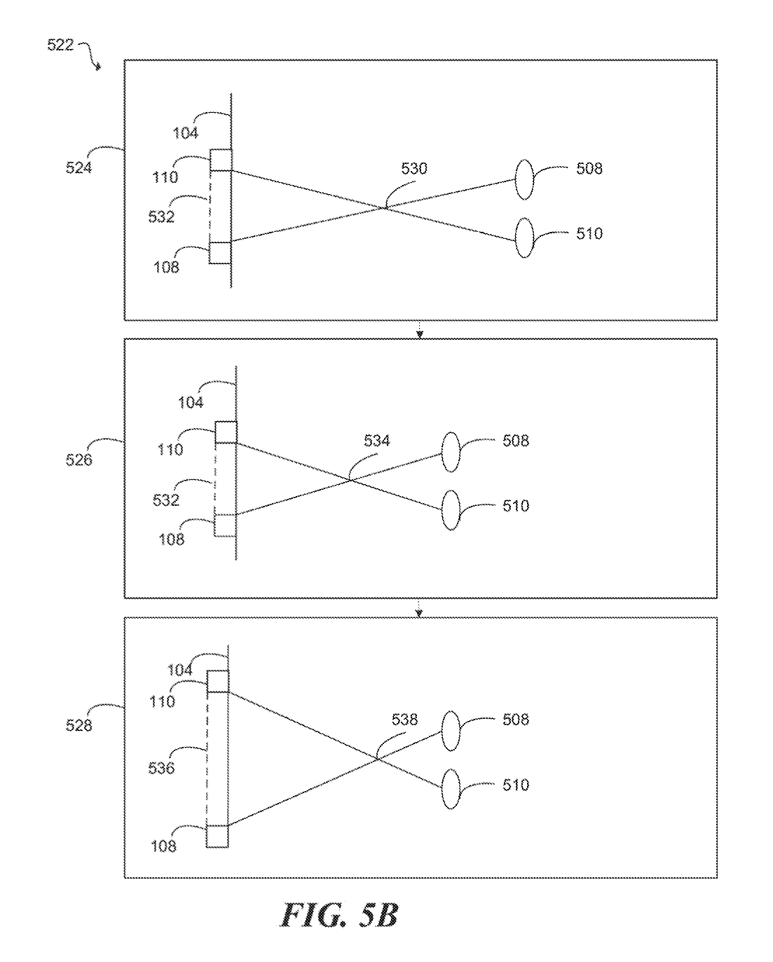

FIG. 5A is a block diagram illustrating one example 500 of updating a relative position of the right eye image 108 and the left eye image 110 based on the distance of a viewer from the display 104. For example, a sensor measuring the distance of the viewer from the display may determine that the distance of the viewer from the display has changed. in some cases, the sensor provides updated information about the viewer's position, and a processor determines whether there has been a change in the distance of the viewer from the display.

The example 500 shows the effect of a viewer moving farther from the display 104. Beginning at block 502, the display 104 shows a right eye image 108 and a left eye image 112 where the right eye image 108 is viewer by a right eye 508 and the left eye image 110 is viewed by a left eye 510. There may be a displacement 518 between the right eye image and the left eye image. The path of the right eye 508 to the right eye image 108 intersects the path of the left eye 510 to the left eye image 110 at an intersection 512. The image may appear to the viewer to be at the position of the intersection 512.

Moving to block 504, the viewer moves away from the display 104 such that the right eye 508 and the left eye 510 are farther from the display 104. The displacement 518 between the right eye image 508 and the left eye image 510 remains the same. The viewer may perceive the image to be at the position of an intersection 514. The intersection 514 is farther in front of the display 104 than the intersection 512 causing the image to appear that it is moving towards the viewer as the viewer moves away from the display 104.

Continuing to block 506, the right eye image 108 and the left eye image 110 are positioned such that they have a displacement 520. The displacement 520 is smaller than the displacement 518. The smaller displacement 520 results in the image appearing at the position of an intersection 516. The intersection 516 is at the same position as the intersection 512 such that the image appears to the viewer to remain in the same position relative to the display 104 as the viewer moves away from the display.

FIG. 5B is a block diagram illustrating one example 522 of updating a relative position of the right eye image 108 and the left eye 110 image based on the distance of a viewer from the display 104. For example, the relative position of the right eye image 108 and the left eye image 110 may be altered as a viewer moves closer to the display 104. Beginning at block 524, the right eye image 108 and the left eye image 110 have a displacement 532. The image appears to the viewer to be at the position of an intersection 530.

Moving to block 526, the viewer moves closer to the display 104 such that the right eye 508 and the left eye 510 are closer to the display 104. The distance between the right eye image 108 and the left eye image remains the same displacement 532. The image appears to the viewer to be positioned at an intersection 534 which is closer to the display 104 than the intersection 530 causing the image to appear to move closer to the display 104 as the viewer moves closer to the display 104.

continuing to block 528, the position between the right eye image 108 and the left eye image 110 is updated such that they have a displacement 536 between them. The displacement 536 is larger than the displacement 532. With the larger displacement 536, the image appears to be at the position of an intersection 538 which is at the same position as the intersection 530.

The focus of a three-dimensional image may be altered based on a target distance of a three-dimensional image from a display. The focus of a three-dimensional image may be altered to make the image appear more realistic. For example, an image intended to appear closer to the display and thus farther from the viewer may be more out of focus than an image intended to appear farther from the display and thus closer to the viewer. In some cases, a storage accessible by a processor includes information about a focus of an object with respect to a target distance. For example, the information may include that an object of one size where a viewer is distance X from the display, should have focus level 2. The relative position of a right eye image and left image may be updated in addition to the focus of the image.

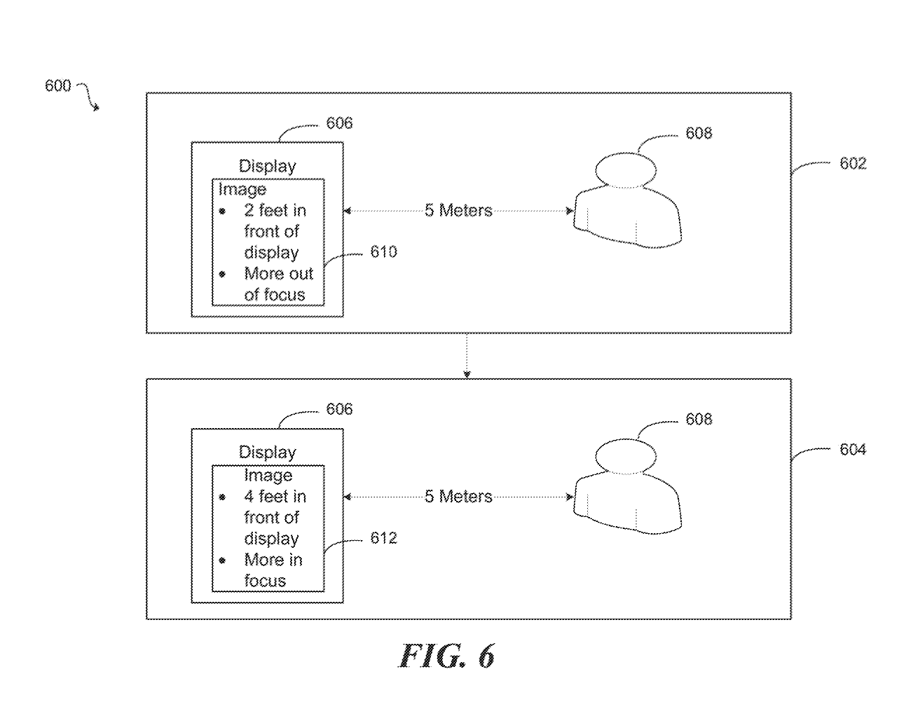

FIG. 6 is a block diagram illustrating one example 600 of updating us of a three-dimensional image 610 based on a target distance from the display 606. Beginning at book 602, a viewer 608 may be 5 meters from the display 606. An image 610 may be displayed where the image 610 appears to be at a target distance 2 meters in front of the display 606, or 3 meters from the viewer 608. Moving to block 604, an image 612 may be displayed to be perceived by the viewer 608 as a target distance of 4 meters in front of the display 606, or 1 meter in front of the viewer 608. The image 612 may be shown to be closer to the viewer 608 and farther from the display 606, for example, by increasing a displacement between a right eye image and a left eye image. The focus of the image 612 perceived as closer to the viewer 608 may be more in focus than the image 610 perceived as farther from the viewer 608.

The relative position of a right eye image and a left eye image may be altered such that the depth of the combined image is altered based on a viewer's distance from a display. For example, an image may be updated such that a viewer sitting dose to a display to play a video game may view images at a different depth than if the game is played from farther away. A target distance of an image to be perceived from a display may be altered based on the distance of the viewer from the display, such as proportional to a viewer's distance from the display, For example, the target distance may be closer to a display for a viewer closer to the display. Changing the depth of an image may make an image easier to view, such as by reducing eye strain. A processor may receive information about a target distance, such as from a storage or from another electronic device, or may determine a target distance based on a standard target distance and a distance from the display.

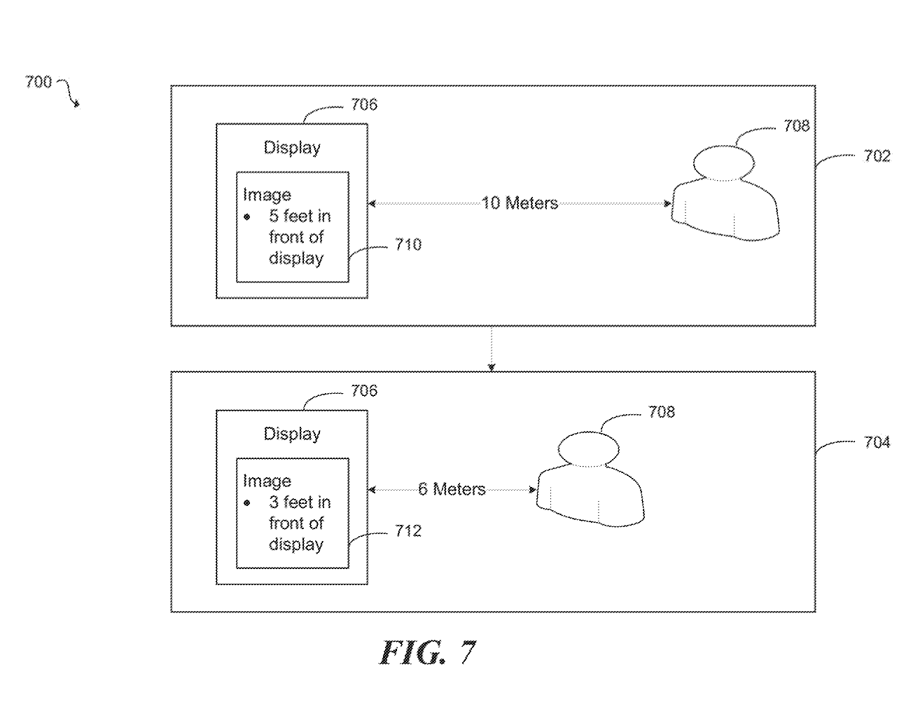

FIG. 7 is a diagram illustrating one example 700 of updating a target distance of a three-dimensional image from a display based on the distance of a viewer from the display. Beginning at block 702, a viewer 708 is 10 meters from a display 706. The display 706 shows a three-dimensional image 710 that has a depth 5 meters in front of the display 706, corresponding to 5 meters in front of the viewer 708. The depth may be created, for example, by adjusting the relative position of a right eye image and a left eye image associated with the image 710.

Moving to block 704, the viewer 708 may be 6 meters in front of the display 706. The viewer 708 may be a different viewer or the same viewer that has moved closer to the display. The image 710 may be shown to be 5 meters from the display and thus 1 meter from the viewer. The image may be updated based on the distance of the viewer 708 from the display 706, such as to make the target distance proportional to the distance of the viewer 708 from the display 706. For example, the target distance may be updated such that it remains half way between the viewer 708 and the display 706. The image 712 is shown with a target depth of 3 meters in front of the display 706 and thus 3 meters in front of the viewer 708 when the viewer 708 is 6 meters in front of the display 706. The image 710 may be updated to the image 712, for example, by increasing an actual or virtual displacement between a right eye image and a left eye image.

In some implementations, the relative position of a right eye mage and a left eye image may be created based on a default distance between a viewer's eyes, such as sixty-four mm. The default distance may be determined based on an estimated average distance between eyes, such as sixty-four mm. The distance sensor may sense the distance of the viewer from the display or a second sensor senses the position between a viewer's eyes. The distance between the viewer's eyes may be determined, for example, by a processor analyzing an image of the viewer's eyes. A processor may receive information, such as from a storage or another electronic device, indicating a relative position between two images associated where a viewer is at a particular distance with a particular distance between the eyes where the relative position will cause the image to be perceived at a target distance from the display.

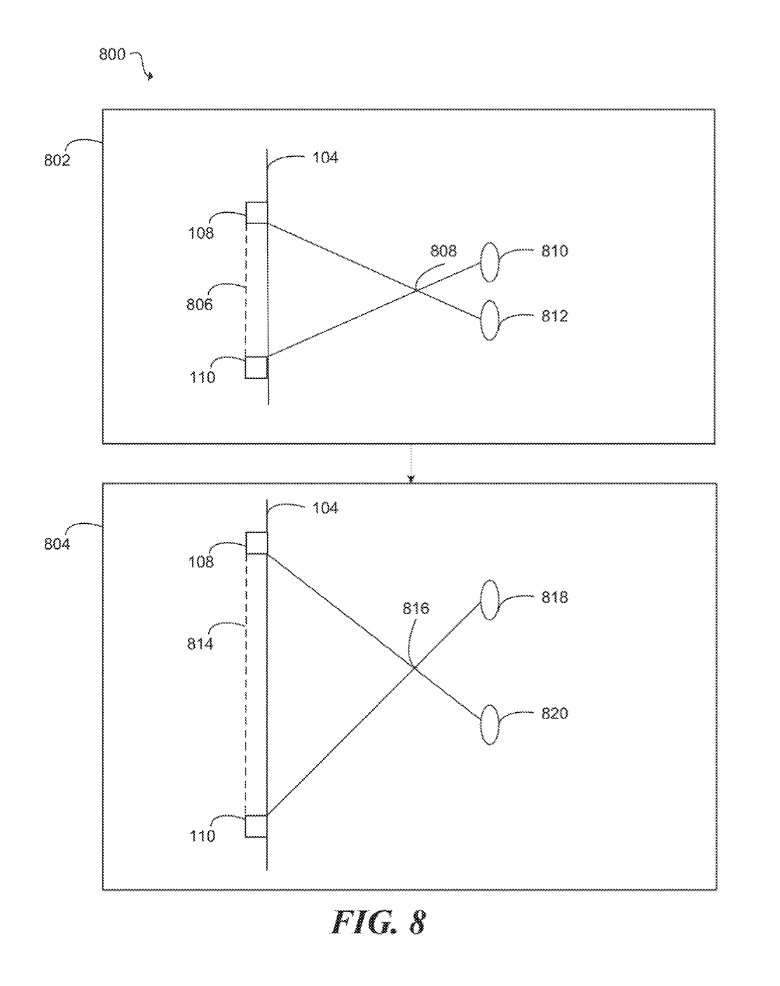

FIG. 8 is a block diagram illustrating one example 800 of updating the relative position of a right eye image and a left eye image based on the distance between a viewer's eyes. The distance between a viewer's eyes may be further taken into account when determining the relative position of the right eye image and the left eye image based on the distance of the viewer from the display. Beginning at block 802, a first viewer has a right eye 810 and a left eye 812. The three-dimensional image created by the right eye image 108 and the left eye image 110 may appear to the viewer to be at the position of an intersection 808 when there is a displacement 806 between the right eye image 108 and the left eye image 110. Moving to block 804, a second viewer views the display 104 with a right eye 818 and a left eye 820. The second viewer has eyes that are farther apart than the eyes of the first viewer. The relative position of the right eye image 108 and the left eye image 110 is altered such that they have a displacement 814. The displacement 814 is larger than the displacement 806. The larger displacement 814 results in the image appearing at the position of an intersection 816 which is at the same position as the intersection 808.

Updating the relative position of a right eye image and a left eye image associated with a three-dimensional image based on the distance of a viewer from a display may provide control over how close or far a viewer perceives an image to be. In addition, determining the relative position of a right eye image and a left eye image based on a distance of a viewer from a display may lead to an image being viewed as a three-dimensional image rather than a separate left eye and right eye two-dimensional image.

1. A computing system to determine a three-dimensional image based on a distance of a viewer from a display, comprising;
a display 104;
a sensor 106 to sense the distance of a viewer from the display 104; and
a processor 102 to determine a relative position of a right eye image and a left eye image based on information from the sensor 106 to make the combined right eye image and left eye image appear to the viewer as if at a target distance from the display 104.

2. The computing system of claim 1, wherein determining the relative position of the right eye image and the left eye image comprises determining an actual displacement between the right eye image and the left eye image,

3. The computing system of claim 1, wherein determining the relative position of the right eye image and the left eye image comprises determining a virtual displacement between the right eye image and the left eye image.

4. The computing system of claim 1, wherein the processor 102 alters a relative position of the right eye image and the left eye image when the sensor senses a change in the distance of the viewer from the display 104.

5. A method to determine a three-dimensional image based on a distance of a viewer from a display, comprising:
determining, by a processor, a relative position of a right eye image and a left eye image based on information from a sensor indicating the distance of a viewer from a display,
wherein the determined relative position comprises a relative position determined to make the combined right eye image and left eye image appear to the viewer as if at a target distance from the display; and
displaying the right eye image and left eye image on the display with the determined relative position of the right eye image and the left eye image.

6. The method of claim 6, wherein determining a relative position of the right eye image ac the left eye image comprises determining a displacement between the right eye image and the left eye image.

7. The method of claim 6, further comprising up ting the target distance based on the distance of the viewer from the display.

8. The method of claim 6, further comprising altering the focus of the right eye image and left eye image based on the target distance.

10. The method of claim 6, further comprising:
receiving information about the distance between the viewer's eyes,
wherein determining a position of the right eye image and the left eye image is further based on the distance between the viewer's eyes.

11. A machine-readable storage medium encoded with instructions executable by a processor to:
determine a comparative position of a right eye image and a left eye image based on information from a sensor indicating the distance of a user from a display,
wherein the determined comparative position comprises a comparative position determined to make the collective right eye image and left eye image appear to the user as if at a desired distance from the display; and
display the right eye image and left eye image on the display based on the determined comparative position of the right eye image and the left eye image.

12. The machine-readable storage medium of claim 11, wherein instructions to determine a comparative position of a right eye image and a left eye image comprise instructions to determine a displacement between the right eye image and the left eye image.

13. The machine-readable storage medium of claim 11, further comprising instructions to update the desired distance based on the distance of the user from the display.

14. The machine-readable storage medium of claim 1, further comprising instructions to change the focus of the right eye image and the left eye image based on the desired distance.

15. The machine-readable storage medium of claim 11, further comprising instructions to:
receive information indicating a change in the distance of the user from the display; and
determine an updated comparative position of the right eye and left image based on the distance of the user from the display.
